(19) United States
(12) Patent Application Publication
(10) Pub. No.: US 2018/0143521 A1
(43) Pub. Date: May 24, 2018

(54) ROTARY ADJUSTER WITH IMPROVED OPTICAL ROTARY POSITION DETECTION

(71) Applicant: PREH GMBH, Bad Neustadt a. d. Saale (DE)

(72) Inventors: Matthias BLUM, Zella-Mehlis (DE); Andreas KAIL, Bad Neustadt (DE)

(73) Assignee: PREH GMBH, Bad Neustadt a. d. Saale (DE)

(21) Appl. No.: 15/802,047

(22) Filed: Nov. 2, 2017

(30) Foreign Application Priority Data
Nov. 23, 2016 (DE) 10 2016 122 585.1

(51) Int. Cl. G03B 21/20; H01H 19/04; G03B 43/02; B41J 33/34; G01D 5/32

(52) U.S. Cl. CPC G03B 21/2046; H01H 19/04; G01D 5/32; B41J 33/34; G03B 43/02

(57) ABSTRACT

The present disclosure relates to a rotary adjuster, including: a housing, a rotary knob mounted in a rotatable manner about a rotation axis (A) on the housing; an optical detection device for detecting a rotary position of the rotary knob and a coding shutter moving synchronously with the rotary knob, wherein the detection device has an optical transmitter and an array of optical receivers, and wherein the coding shutter and the detection device are designed to detect the rotary position of the rotary knob by means of the number of the receivers of the array illuminated by the transmitter and/or by means of an illumination intensity of one or more receivers of the array.

This application claims priority to the German Application No. 10 2016 122 585.1, filed Nov. 23, 2016, now pending, the contents of which are hereby incorporated by reference.

The present disclosure relates to a rotary adjuster with an improved optical rotary position detection. Input devices, particularly rotary adjusters, with an contactlessly functioning optical position detection are widely known. In conventional optically detecting rotary adjusters, for example, one or more light barriers with a fork-like design are provided whose optical path is interrupted, in a position-dependent manner, by a shutter rotating in synchronicity with the rotary knob in order thus to detect the position and/or the rotary direction of the rotary knob.

DE 10 2004 020 827 A1 discloses rotary adjusters with a transmitter and an array of circumferentially distributed receivers aligned with one another. No light guide is provided between the receiver and the transmitter.

DE 10 2008 017 069 A1 discloses a rotary adjuster with an array of transmitters and exactly one receiver, wherein the light from the transmitters is conducted to a receiver via a stationary light guide through a coding ring moving synchronously with the rotary knob, in order to be able to detect a position by means of the illumination intensity and the coding. The embodiment shown is comparatively voluminous.

Basically, there is a need for a very exact position detection, without sacrificing freedom from wear of the optical detection.

Against this background, there was a need for a solution for a rotary adjuster as an input device with, in comparison, an improved high-resolution position detection functioning contactlessly, which, in particular, can be produced in a construction space-saving and inexpensive manner, and whose functional reliability can be permanently ensured in an improved manner. This object is achieved with a rotary adjuster according to claim 1. An equally advantageous use is the subject matter of the independent use claim. Advantageous embodiments are in each case the subject matter of the dependent claims. It must be noted that the features cited individually in the claims can be combined with each other in any technologically meaningful manner and represent other embodiments of the present disclosure. The description, in particular in connection with the figures, additionally characterizes and specifies the present disclosure.

The present disclosure relates to a rotary adjuster having a housing and a rotary knob mounted in a rotatable manner about a rotation axis on the housing. The term rotary knob is not to be understood to be limiting, and according to the present disclosure, it should be an operating part configured in an arbitrary manner that makes at least a rotary input possible.

According to the present disclosure, an optical detection device for detecting a rotary position of the rotary knob and a coding shutter moving synchronously with the rotary knob are also provided. According to the present disclosure, the detection device has at least one, preferably exactly one, optical transmitter, e.g. a light-emitting diode with an SMD design, and an array of optical receivers. Preferably, the optical receivers are combined in an assembly group. For example, the array is a single-line array, such as a single-line image sensor with a CCD construction. According to the present disclosure, the coding shutter and the detection device are designed to detect the rotary position of the rotary knob by means of the number of the receivers of the array illuminated by the transmitter and/or by means of an illumination intensity of one or more receivers of the array. For example, a combination of both detection options is used in order to enable as fine a position detection as possible with a resolving power that goes beyond what is determined merely by the number of receivers. Further, the rotary adjuster according to the present disclosure has a light guide disposed in the beam path between the transmitter and the receivers of the array and moving synchronously with the rotary knob, in order to be able in this way to dispense with “visual contact” between the receiver and the plurality of receivers. Thus, detection becomes less susceptible to interference.

The light guide may be configured in such a way that is carries out light deflection. For example, the receivers and the transmitter are disposed in such a way that the shortest optical path between the transmitter and one receiver of the array, respectively, undergoes a deflection of 180° in total for all receivers, e.g. two deflections by 90° in each case.

According to the present disclosure, the light guide is configured as a rotationally symmetric body in its section extending between the receiver and the array and is mounted in a rotatable manner about its axis of rotational symmetry. Preferably, the light guide, as a whole, is configured as a rotationally symmetric body. Due to the rotationally symmetric configuration, which is provided at least in the aforementioned section, a largely position-independent, conformal light passage is achieved, so that, beside the position detection, other necessary calibration processes for determining the position from the measured illumination intensities may either be omitted entirely or reduced to a minimum. This is supposed to refer to the outer circumference of said section. According to the present disclosure, slight deviations not corresponding to a strict rotation symmetry, e.g. latching means as fastening means, e.g. latching lugs for connection to the above-mentioned coding shutter, may be provided in said section. For example, the light guide has a cylindrical outer circumference in the section. For example, the light of the transmitter is coupled into the light guide via a first cylindrical lateral surface and, via a second cylindrical location offset in the axial direction from the aforementioned first lateral surface, coupled out of the second lateral surface in the direction of the receivers. For example, the first cylindrical lateral surface is additionally configured in a manner offset in the radial direction relative to the second cylindrical lateral surface.

According to a preferred embodiment, the rotary knob and the light guide are disposed coaxially in order to save construction space.

According to a preferred embodiment, the light guide forms an axis section of the rotation axis of the operating part. Preferably, the axis section defining the light guide is supported on the housing in order to avoid a wobbling movement of the light guide that affects the light transmission.

Preferably, an end section of the light guide, together with the housing, forms a point bearing arrangement. This enables a self-centering bearing arrangement of the light guide in order to achieve a position-independent light transition, i.e. a uniform light transition over the various positions of the rotary adjuster, from the transmitter to the receivers. Preferably, the housing has a conical spike projection engaging into a conical depression of the light guide.

Preferably, another axis section of the rotating axis, which preferably establishes the connection with the rotary knob, is connected to the light guide by means of a plug-in connection. For example, they are connected to each other by positive fit.

Preferably, the array is defined by a single-line assembly extending in the direction of the rotation axis. Preferably, the receiver is offset relative to the array in the extending direction, which facilitates the application of the transmitter and receivers of the array to a common circuit board and saves construction space.

Preferably, the light guide and the array are disposed in such a manner that a sub-set of the receivers is able to receive light of the receiver independently of the position of the coding shutter, for example because the light guide and the array protrude over the coding shutter. Thus, it is possible to monitor the function of the transmitter or to calibrate its transmitting power, for example in order to counteract aging phenomena, such as a transmitting power that decreases as the operating time increases, or a decreasing sensitivity of the receivers.

According to a preferred embodiment, a latching device is provided in order to fix the rotary adjuster in predefined latching positions, e.g. a latching contour and a latching member, such as a latching spring, which is in elastically biased engagement with the latching contour. Preferably, the latching contour is formed on the coding shutter, into which a latching member on the housing engages in order thus to obtain an offset-free assignment between the respective latching position and coding shutter position.

In order to save construction space, the coding shutter is configured as a ring surrounding the light guide, which preferably forms a coding contour, such as a saw-tooth contour, on its end face. Preferably, the ring-shaped coding shutter is supported on a collar-like projection extending around the light guide. For example, the collar-like projection defines the above-mentioned first cylindrical lateral surface.

Furthermore, the present disclosure relates to the use of the rotary adjuster in one of its above-described embodiments in a motor vehicle.

The present disclosure is explained further with reference to the following figures. The Figures are to be understood only as examples and merely represent a preferred embodiment. In the figures:

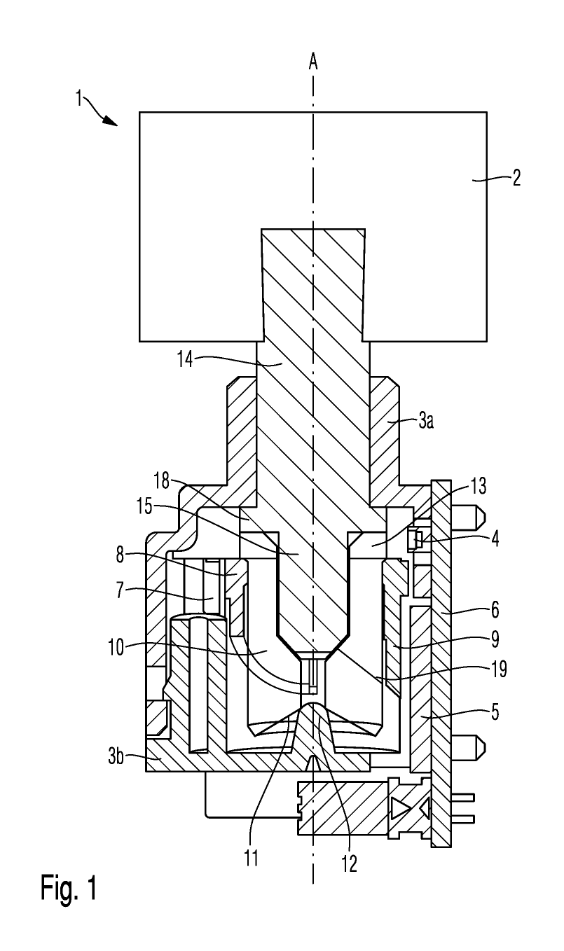

FIG. 1 shows a vertical schematic cross-sectional view through an embodiment of the rotary adjuster of the present disclosure;

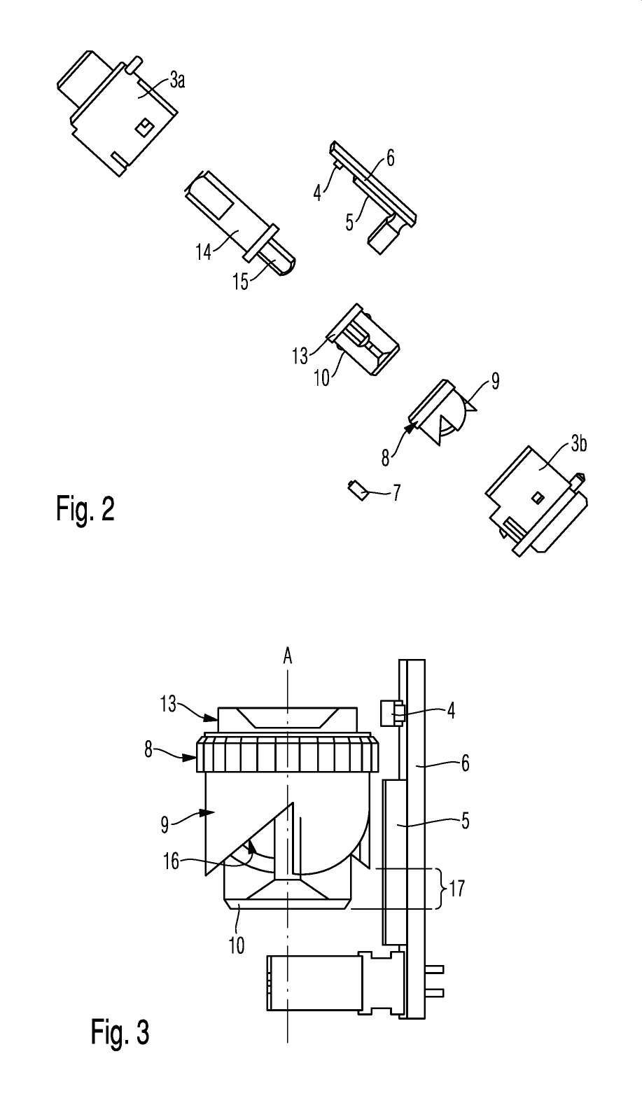

FIG. 2 shows a schematic exploded view of the embodiment of the rotary adjuster of the present disclosure shown in FIG. 1;

FIG. 3 shows a schematic detailed view of the rotary adjuster of the present disclosure from FIG. 1.

FIG. 1 shows an embodiment of the rotary adjuster 1 of the present disclosure. It has a two-part housing with the housing parts 3a and 3b. The two housing parts 3a and 3b are mutually fixed by means of latching means. The rotary adjuster 1 has a rotary knob 2 which is mounted in a rotatable manner about an axis A on the housing 3a, 3b via a first axis section 14 consisting of an opaque plastic material and a second axis section consisting of transparent plastic material forming a light guide 10. The first axis section 14 is supported on the housing by means of a collar-like projection 18. The first axis section 14 and the light guide 10 functioning as a second axis section are connected to each other by means of a positive plug-in connection and define the rotation axis A of the rotary knob 2. The light guide 10 is configured to be rotationally symmetric about the rotation axis A as the axis of rotational symmetry and has at its end facing away from the rotary knob 2 a conical recess 11, into which a spike 12 on the housing engages in order thus to effect a self-centering point bearing arrangement of the rotary knob 2 and the light guide 10. A coding ring 9 is connected via latching members to the light guide 10 in a non-rotatable manner. On its outer circumference, the coding ring 9 has a latching contour 8 into which a latching spring provided as a latching member 7 engages in an elastically biased manner in order to fix the rotary knob 2 at predefined positions in a latching manner, and in order to generate residual haptics during the rotary operation of the rotary knob 2. The basic structure becomes clear from the exploded view of FIG. 2. The rotary position detection is illustrated by means of FIG. 3. Light of an optical transmitter 4 disposed on a circuit board 7 is coupled into the light guide 10 via the outer circumference of the substantially cylindrical light guide 10, specifically via a first cylindrical lateral surface 13 of the light guide 10, in order to propagate in the light guide 10 and to exit at a location offset in the axial direction A via a second cylindrical lateral surface of the light guide 10 and to be received by an array 5 of optical receivers, in this case a single-line array 5 extending parallel to the rotation axis and combined to form an assembly group. The transmitter 4 and the receiver 5 are stationary while the light guide 10 rotates above the detection device consisting of the transmitter 4 and the receiver 5 during the rotary operation. The first lateral surface 13 is offset towards the outside relative to the second lateral surface 19 and forms a contact flange for the ring-shaped coding shutter 9.

Due to its self-centering bearing arrangement and the rotational symmetry, the light passage through the light guide 10 is largely independent of the position of the rotary knob 2, whereas the light exiting from the light guide 10, due to the saw tooth-like coding contour 16 formed in the coding ring 9, is blocked out or let through according to position for the purpose of position detection, so that a position detection is possible with the number of the illuminated receivers of the array 5 and with the illumination intensity attained in the process.

As can be seen in FIG. 3, the saw tooth-shaped coding contour 16 has a periodicity of 90°. The transmitter 4 and the array 5 of receivers are disposed on a common circuit board 6 and are disposed along a direction parallel to the rotation axis A. As FIG. 3 also shows, the light guide 10 and the array 5 protrude over the ring-shaped coding shutter 9. Even though a calibration is, in principle, dispensable due to the high level of symmetry and the bearing arrangement of the light guide 10, which is precise because it is self-centering, the unblocked light from the protruding part 17 of the light guide 10 transmitted to the protruding part of the array 5, in addition to the function of merely monitoring function, may also be used for calibration in order to compensate aging phenomena of the transmitter 4 and the receivers 5, for example.

1. A rotary adjuster, comprising:
a housing, a rotary knob mounted in a rotatable manner about a rotation axis (A) on the housing, an optical detection device for detecting a rotary position of the rotary knob and a coding shutter moving synchronously with the rotary knob;
wherein the detection device has an optical transmitter and an array of optical receivers, and wherein the coding shutter and the detection device are designed to detect the rotary position of the rotary knob by means of the number of the receivers of the array illuminated by the transmitter and/or by means of an illumination intensity of one or more receivers of the array, wherein the rotary adjuster has a light guide disposed in the beam path between the transmitter and the receivers and moving synchronously with the rotary knob, characterized in that the light guide is configured as a rotationally symmetric body in its section extending between the receiver and the array and is mounted in a rotatable manner about its axis of rotational symmetry.

2. The rotary adjuster of claim 1, wherein the rotary knob and the light guide are arranged coaxially.

3. The rotary adjuster of claim 1, wherein the light guide forms an axis section of the rotation axis (A) of the rotary knob.

4. The rotary adjuster of claim 1, wherein an end section of the light guide, together with the housing, forms a point bearing arrangement.

5. The rotary adjuster of claim 1, wherein another axis section of the rotating axis (A) is connected to the light guide by means of a plug-in connection.

6. The rotary adjuster of claim 1, wherein the array is defined by a single-line assembly extending in the direction of the rotation axis.

7. The rotary adjuster of claim 1, wherein the light guide and the array are disposed in such a manner that a sub-set of the receivers is able to receive light of the receiver independently of the position of the coding shutter, wherein the light guide and the array protrude over the coding shutter.

8. The rotary adjuster of claim 1, wherein the coding shutter has a latching contour into which a latching member on the housing engages.

9. The rotary adjuster of claim 1, wherein the coding shutter is configured as a ring surrounding the light guide and preferably forms a coding contour, such as a saw-tooth contour, on its end face.

10. Use of the rotary adjuster according to claim 1, in a motor vehicle.
